(19) United States
(12) Patent Application Publication
(10) Pub. No.: US 2017/0178181 A1
(43) Pub. Date: Jun. 22, 2017

(54) CLICK THROUGH RATE PREDICTION CALIBRATION

(71) Applicant: LinkedIn Corporation, Mountain View, CA (US)

(72) Inventors: Kun Liu, San Jose, CA (US); Wen Pu, Santa Clara, CA (US); Rohan Ramanath, Saratoga, CA (US); Yuan Gao, Seattle, WA (US)

(21) Appl. No.: 14/972,174

(22) Filed: Dec. 17, 2015

(51) Int. Cl. G06Q 30/02

(52) U.S. Cl. CPC G06Q 30/0246; G06Q 30/0275

(57) ABSTRACT

Techniques are provided for adjusting a predicted user selection rate (e.g., a “click-through” rate) of a content item. In one technique, a model is used to generate a predicted user selection rate of a first content item. A difference between (1) an observed user selection rate of the first content item and (2) a previous predicted user selection rate of the first content item is determined. The predicted user selection rate is modified, based on the difference, to generate an adjusted predicted user selection rate of the first content item. Then, based on the adjusted predicted user selection rate, a score of the first content item is generated. The first content item is displayed based on the score. For example, other content items may be scored in a similar fashion. The one or more content item with the highest scores are displayed.

### TECHNICAL FIELD

The present disclosure relates to displaying digital content and, more particularly to, predicting user behavior with respect to different digital content items.

### BACKGROUND

The Internet has allowed data distribution on a massive scale. Different content providers who leverage Internet technologies have different goals in providing content. Some content providers desire to sell a product or service, some desire to attract as many users to increase advertising revenue, and some desire to provide information for purely altruistic reasons. Regardless of which goal a content provider is pursuing, the content provider may have to choose which content item, from among multiple content items, to display due to (1) the limited screen size of the device that a user is utilizing to connect to the content provider and (2) the number of possible content items that may be displayed to the user at one time. Types of content items vary widely, examples of which include blog postings, news or sports articles, advertisements, videos, audio recordings, and slideshows.

If the wrong content items are displayed or if the right content items are displayed in the wrong order, then, not only will end-users not maximize their experience with the content provider, but the content provider may end up forfeiting a significant amount of revenue. Thus, determining which content item(s) to display and, optionally, an order in which to display content items, becomes a problem that many content providers are attempting to solve.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a flow diagram that depicts an example process for predicting a particular user behavior with respect to a candidate content item to display, in an embodiment;

FIG. 2 is a chart that illustrates changes over time to observed user selection rates and predicted user selection rates for a particular content item;

FIGS. 3A-3B are a flow diagram that depicts a process for predicting a particular user behavior with respect to one or more candidate content items to display, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

One approach for determining which content items to display is to create a prediction model that takes into account multiple factors, such as characteristics of the content item and the user. Then, when a content provider with such a prediction model is determining which content items to display to a particular user, the content provider inputs, into the prediction model, attributes about possible content items, the particular user, and/or the context. The set of content items to consider when determining which to display may be initially restricted based on one or more criteria, such as time of day, attributes of the particular user, which device the particular user is using, etc. An output of the model is a prediction (e.g., reflected in a number between 0 and 1) of a probability that the particular user will perform a particular action relative to a particular item, such as selecting the content item or spending certain amount of time viewing the content item. Thus, a prediction is generated for each content item in a candidate set of content items. Generally, the content items associated with the highest prediction values will be displayed to the particular user. If each content item is associated with a bid amount, representing a direct award (e.g., monetary compensation) to the content provider, then, for each content item in the candidate set of content items, the bid amount and prediction are multiplied to generate a score for that content item. The resulting scores are used to rank the candidate set of content items.

A problem with this approach is that practically every prediction is either overestimated or underestimated. Some of the bias (e.g., over estimation or under estimation) may be systematic and inherent in the mechanism(s) most online content distribution platforms use. Such bias is impossible to eliminate by improving the prediction model alone.

### General Overview

Techniques are provided for more efficiently predicting user behavior with respect to multiple content items in order to determine which content items to display. A prediction of user behavior with respect to a particular content item is made based on multiple factors, such as one or more attributes of the user to whom that content item may be displayed and/or one or more attributes of the content item. Then, actual (known) user behavior for that content item (or a related item) in the past is compared to previously predicted user behavior for that content item. The difference between the two may be used to adjust the prediction. The adjusted prediction is then used to determine when or where the content item is to be displayed relative to other content items.

### System Overview

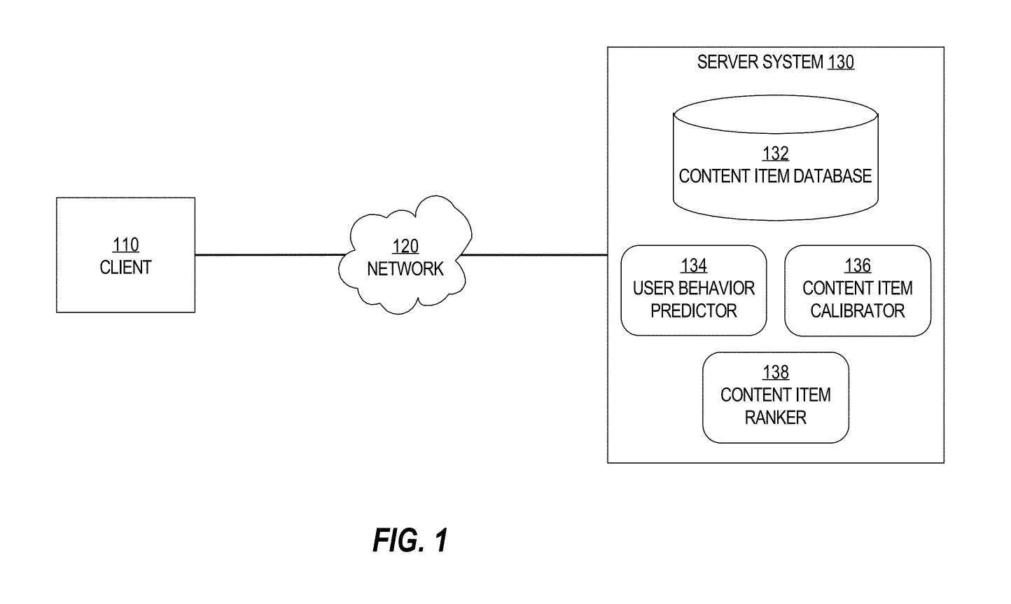

FIG. 1 is a block diagram that depicts a system 100 for presenting content items to a user, in an embodiment. System 100 includes a client 110, a network 120, and a server system 130. Although only one client 110 is depicted, many clients may interact with server system 130, which provides content items to the client in order to present the content items to end-users.

Client 110 is an application or computing device that is configured to communicate with server system 130 over network 120. Examples of computing devices include a laptop computer, a tablet computer, a smartphone, a desktop computer, and a Personal Digital Assistant (PDA). An example of an application includes a dedicated application that is installed and executed on a local computing device and that is configured to communicate with server 130 over network 120. Another example of an application is a web application that is downloaded from server system 130 and that executes within a web browser executing on a computing device. Client 110 may be implemented in hardware, software, or a combination of hardware and software.

Network 120 may be implemented on any medium or mechanism that provides for the exchange of data between client 110 and server system 130. Examples of network 120 include, without limitation, a network such as a Local Area Network (LAN), Wide Area Network (WAN), Ethernet or the Internet, or one or more terrestrial, satellite or wireless links. For example, client 110 generates and transmits a Hypertext Transport Protocol (HTTP) GET request that includes a uniform resource locator (URL). A domain portion of the URL is translated into an IP address and the GET request is transmitted to a destination machine that is assigned the IP address.

Server system 130 includes a content item database 132, a user behavior predictor 134, a content item calibrator 136, and a content item ranker 138. Each of user behavior predictor 134, content item calibrator 136, and content item ranker 138 may be implemented in hardware, software, or a combination of hardware and software. Each of content item database 132, user behavior predictor 134, content item calibrator 136, and content item ranker 138 is described in more detail below.

Server system 130 may provide one or more web services, such as a social networking service. Examples of social networking service include Facebook, LinkedIn, and Google+. Although depicted as a single element, server system 130 may comprise multiple computing elements and devices, connected in a local network or distributed regionally or globally across many networks, such as the Internet. Thus, server system 130 may comprise multiple computing elements other than the elements depicted in FIG. 1.

### Content Item Database

Content item database 132 stores content items that are candidates for presentation (e.g., display) at client 110 and other clients (not depicted). A content item may comprise an image, a video (that is playing or paused), text, or any combination thereof. Examples of content items include advertisements, a combination of text and an image related to a news/blog article, etc. A content item may contain a link (or URL) to another content item that is stored in content item database 132, another database of server system 130 (not depicted), or a third-party storage system, such as one that is managed by a third-party website. Thus, user selection of a content item may cause a web page from a third-party website to be displayed at client 110.

The content items in content item database 132 may include content that client 110 is able to specifically request, generally request, or may be unsolicited content, such as advertisements. An example of generally-requested content is content on a news website that contains numerous articles. The news website needs to determine which content to display first since abstracts or links to all the articles cannot fit within a single screen view provided by a computing device. Thus, a request from client 110 does not specify which specific content to display, but the request is generally for news articles. It is up to the news website to display abstracts of articles (and/or images associated therewith) that are determined to be most likely viewed and selected by the user in order to keep the user interested and engaged.

### User Behavior Predictor

User behavior predictor 134 makes a prediction regarding a likelihood that a user (whether a specific user, a user that belongs to a particular class of users (e.g., CEOs, doctors, users from China), or a generic user) will perform a particular action with respect to a particular content item. An example of user behavior with respect to a content item is selecting the content item, such as with a mouse or with a finger on a touch screen of a mobile device. The rate at which users select a content item is referred to herein as the “click-through rate” (or CTR). Thus, user behavior predictor 134 may predict a CTR with respect to (a) content items as a whole, (b) a specific group of content items (e.g., new content items or content items related to sports), or (c) an individual content item. Other examples of user behavior with respect to a content item include an amount of time spent viewing the content item, scrolling behavior with respect to the content item, selecting an icon (e.g., a “like” icon or a star icon) that is displayed adjacent to the content item, highlighting text within the content item, and providing voice input when the content item is presented.

The value that user behavior predictor 134 generates for a content item is referred to herein as a “predicted value,” an example of which is predicted CTR. In an embodiment, a predicted value for a content item is generated once for a period of time (e.g., a day) and is associated with that content item for the period of time. In this way, if the content item is a candidate for presentation to a user multiple times, then the predicted value does not have to be calculated each time.

In an embodiment, user behavior predictor 134 uses a model to generate a predicted value for a content item. The model is trained based on multiple features. Example types of such features include user-related features, content item-related features, and context features. Examples of user-related features include a user's current geographic location, residence information, current employer, job title, industry, academic institution(s) attended, degrees earned, number of connections in a social network, identification of one or more of those connections, skills, endorsements, identification of one or more endorsers, interests, hobbies, and history of selecting content items presented to the user through server system 130.

Examples of content item-related features include type of content (e.g., text, image, video, graphics), source of the content item (e.g., if the content item is from server system 130, an advertiser, or a third party relative to server system 130), subject matter of content (e.g., sports, news, clothing, vehicle, entertainment, leisure), size (e.g., number of pixels in height and/or width), font size (if there is text), and font color(s).

Examples of context features include time of day in which a content item is to be presented, type of client device through which the content item is to be presented (e.g., tablet, desktop, laptop, mobile phone), type of operating system, identification of one or more applications running on the client device, and subject matter of content that client 110 requested and/or is currently displayed.

The model may be trained by one or more other computing elements of server system 130 (not depicted) or by a different entity altogether, such as a third-party respect to the entity that owns or manages server system 130. The model is trained based on a history of known user interactions with certain content items (e.g., “click throughs” or viewing). The training data may be limited to user interactions in, for example, the last month, week, or day. Embodiments are not limited to any particular technique for generating a model. An example technique is logistic regression.

In an embodiment, server system 130 includes multiple user behavior predictors 134 or multiple models, one for each different type of user behavior that is tracked. For example, one model is generated for user selections (or “click throughs”) and another model is generated for user viewing time.

### Per-Content Item Calibration

Content item calibrator 136 determines or calculates an adjustment that is to be applied to a predicted value generated by user behavior predictor 134 for a particular content item. Content item calibrator 136 determines the adjustment associated with the particular content item based on a history of user behavior with respect to the particular content item or to content items that are similar to the particular content item. This latter class of content items is useful when the particular content item is “new” or has not been presented (e.g., displayed) before. Therefore, there is no user behavior history related to such a content item.

Server system 130 keeps track of user behavior with respect to multiple content items. For example, server system 130 creates a record for each selection of a content item by a user of server system and each non-selection (or “non-event”) of a content item that is presented to a user. A record may identify the content item (e.g., with an item ID), the user (e.g., with a member ID), the date, the time of day of selection or presentation, etc. Once they are stored, records may be aggregated on a time basis. For example, all records indicating that a particular content item was displayed on a particular date are analyzed to determine a rate of selection or CTR. This is referred to herein as the “observed CTR,” which is a sub-category of “observed user behavior.” Additionally or alternatively, records may be aggregated based on a dimension other than time, such as types of content item, sources of content items, content item display properties, and predicted value. For example, records about different, “new” content items are aggregated to indicate observed CTR with respect to the new content items, or content items for which no, or a little, CTR history is known. As another example, records about content items that have the same or similar (e.g., within a certain range) predicted CTR are aggregated to compute an observed CTR.

Additionally, server system 130 stores a record indicating one or more predicted CTRs during a particular time period. A “predicted CTR” may be for a particular instant in time or aggregated over a certain time period, such as a day, two days, a week, etc. For example, a predicted CTR generated on a particular day for a particular content item may be an average or median of all predicted CTRs that are were generated on that particular day for that particular content item. Before performing an aggregation operation (e.g., mean, median, max, min) on a set of predicted CTRs, the set of predicted CTRs may be modified to exclude outliers.

More complex aggregation functions (e.g., other than mean/median) may be used. For example, a function or calibration mapping is “learned” or computed from events using isotonic regression, which is a type of numerical analysis that involves finding a weighted least-squares fit to a vector (with a weights vector) subject to a set of non-contradictory constraints. Therefore, the calibration can be much more general than just compensates the difference using an error. Such a isotonic regression-based function takes a predicted CTR and the aggregated events and outputs a calibrated (or adjusted) predicted CTR.

As noted previously, content item calibrator 136 determines an adjustment to a prediction (generated by user behavior predictor 134) of particular user behavior with respect to a particular content item based on a difference between (in the case of CTR) observed CTR and predicted CTR. For example, if, over the last week, the observed CTR of a particular content item is greater than the predicted CTR of the particular content item, then a positive adjustment is determined and the adjustment is combined (e.g., added) to the predicted CTR generated by user behavior predictor 134. The adjustment may be a fixed value regardless of the determined difference. Alternatively, the adjustment may vary depending on the determined difference. For example, if the observed CTR of content item A for the last day is 0.015 and the predicted CTR of content item A for the last day is 0.012, then the adjustment is 0.015−0.012=0.003.

Therefore, an adjustment is determined on a per-content item basis. Thus, different content items may be associated with different adjustments. Additionally, the difference between an observed CTR and a predicted CTR of a particular content item may change over time, such that at one time the observed CTR is greater than the predicted CTR and at another time the observed CTR is less than the predicted CTR.

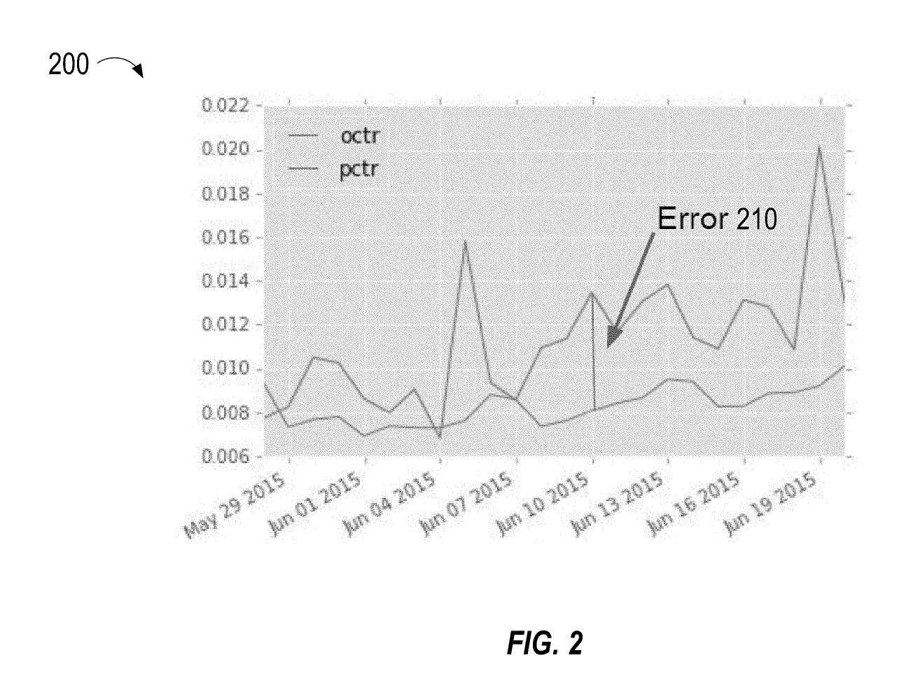

FIG. 2 is a chart 200 that shows the change in observed CTRs and predicted CTRs for a particular content item over time. In this depicted example, the observed CTR is almost always higher than the predicted CTR. For other content items, the observed CTR may be generally lower than the predicted CTR. Error 210 indicates a difference between an observed CTR and a predicted CTR on Jun. 10, 2015. The observed CTR on that date is about 0.0135 and the predicted CTR on that date is about 0.008. Thus, the difference is about 0.0055.

In some cases, a content item is new such that the content item has not been presented yet to any user or an observed CTR is not yet calculated (e.g., if an observed CTR is calculated daily and the new content item has been presented for only the last 18 hours). In this case, a difference between an observed CTR and a predicted CTR of one or more other content items is determined. The “other” content items may be limited to content items that were new previously. The assumption here is that new content items have generally consistent differences between observed and predicted CTRs (for example, predicted CTRs of new content items are generally lower than observed CTRs for such content items by a factor of 0.88). “Other” content items may be limited to (new and/or “old”) content items from the same content provider (e.g., advertiser if the content items are advertisements). In addition to or alternative to age and source, “other” content items may be determined based on type, subject matter, content provider or source, and/or display properties (e.g., size, colors, font size, font color, graphics). For example, if a new content item is related to cars and statistics on observed and predicted CTRs of car-related content items is maintained, then those statistics may be leveraged in order to compute an adjustment for the new content item.

Thus, before calculating a difference between an observed CTR and a predicted CTR of a content item, content item calibrator 136 may determine whether such user selection history is available. The determination may be made based on a flag or variable that is stored as metadata of the content item. The flag or variable is set when at least one observed CTR and one predicted CTR (for the same time period) are stored in association with the content item.

The granularity of a calculated (e.g., observed/predicted CTR) may be based on any time range, such as a few minutes, hours, days, or weeks. If, for example, the smallest granularity of a calculated CTR is a day, then a weekly CTR (or a 4-day CTR) may be calculated by averaging multiple day CTRs. For example, a daily CTR may be calculated for the particular content item whose CTRs are displayed in FIG. 2. In order to calculate a difference between an observed CTR and a predicted CTR, (1) the observed CTR is determined to be the average (or, for example, median, maximum, or minimum) of the observed daily CTRs from May 28 to June 20 and (2) the predicted CTR is determined to be the average of the predicted daily CTRs through the same time range.

In an embodiment, when aggregating CTRs (or other tracked user behaviors), a weight is added to CTR values that are more recent in time. For example, a difference between an observed CTR and a predicted CTR over the last four days is to be determined and individual day CTR values are stored. An “average” observed CTR for the four days may be calculated by weighting the observed CTRs on days 2-5 higher than the observed CTR on day 1. For example, a weight for the observed CTR for day 1 may be 0.8, a weight for the observed CTR for day 2 may be 0.9, a weight for the observed CTR for day 3 may be 1, a weight for the observed CTR for day 4 may be 1.1, and a weight for the observed CTR for day 5 may be 1.2. In this way, observed CTRs for later days are given more weight. The same weighting may be done to the corresponding predicted CTRs.

In a related embodiment, different content items or different classes of content items may be associated with different weightings. For example, a set of weightings for content items from a first advertiser is different than a set of weightings for content items from a second advertiser. In addition to, or alternative to, source, classes (or groups) of content items may be identified or organized based on one or more of type of content item, subject matter of the content items, presentation (e.g., display) properties, and time or date of presentation.

Other factors may be taken into account when generating an adjustment for a predicted CTR (or other user behavior) for a particular content item. For example, if the current day is a Monday, then a generated adjustment may be capped (e.g., no greater than a 0.1 adjustment) or “bumped” (e.g., increase by a factor of 1.2). Analyzing observed CTRs versus predicted CTRs over time may result in determining that certain days of the week, dates (e.g., holiday weekend; Valentine's Day), or time of day are associated with certain differences between observed and predicted CTRs. For example, Christmas Day may be associated with much higher observed CTRs than usual. Thus, if the difference between an observed CTR and a predicted CTR of a particular item is a certain amount over the last three days and the current day is Christmas, then the difference may be adjusted upward (such as by a certain factor) due to the holiday.

### Content Item Ranker

Content item ranker 138 ranks a set of content items based, at least partially, on output from user behavior predictor 134 (and, optionally, from content item calibrator 136 if user behavior predictor 134 does not apply a determined adjustment to the “raw” predicted CTR) for each content item in the set. The result of combining (e.g., adding) a “raw” predicted CTR (generated by user behavior 134) with an adjustment (determined by content item calibrator 136) is referred to as an “adjusted predicted value” or “adjusted predicted CTR.” Therefore, the higher the adjusted predicted CTR of a particular content item relative to adjusted predicted CTRs of other content items, the more likely the particular content item will be presented to a user, e.g., of client 110.

In a scenario where content items are advertisements originating from different advertisers (which may be third-parties relative to the party that owns/manages server system 130), each content item may be associated with a bid price. A bid price is amount an advertiser will pay if the corresponding content item is selected, displayed, viewed for a particular amount of time, or interacted with in some other way. Different advertisements may be associated with different bid prices, even advertisements from the same advertiser. The higher the bid price, the more likely the corresponding content item will be presented to a user (e.g., of client 110) relative to other content items. However, even with a relatively high bid price, a content item may not be presented if the corresponding adjusted predicted value is much less than the adjusted predicted values of other content items.

In order to rank multiple content items relative to each other, an operation is performed for each content item that takes into account the adjusted predicted value of the content item and the bid price of the content item. For example, the adjusted predicted value is multiplied by the bid price to generate an expected value. An expected value represents how much revenue the entity or party that owns or manages server system 130 expects to earn if the corresponding content item is displayed.

Content item ranker 138 may take one or more inputs other than the adjusted predicted value, some of which inputs are described in more detail below.

### Process Overview

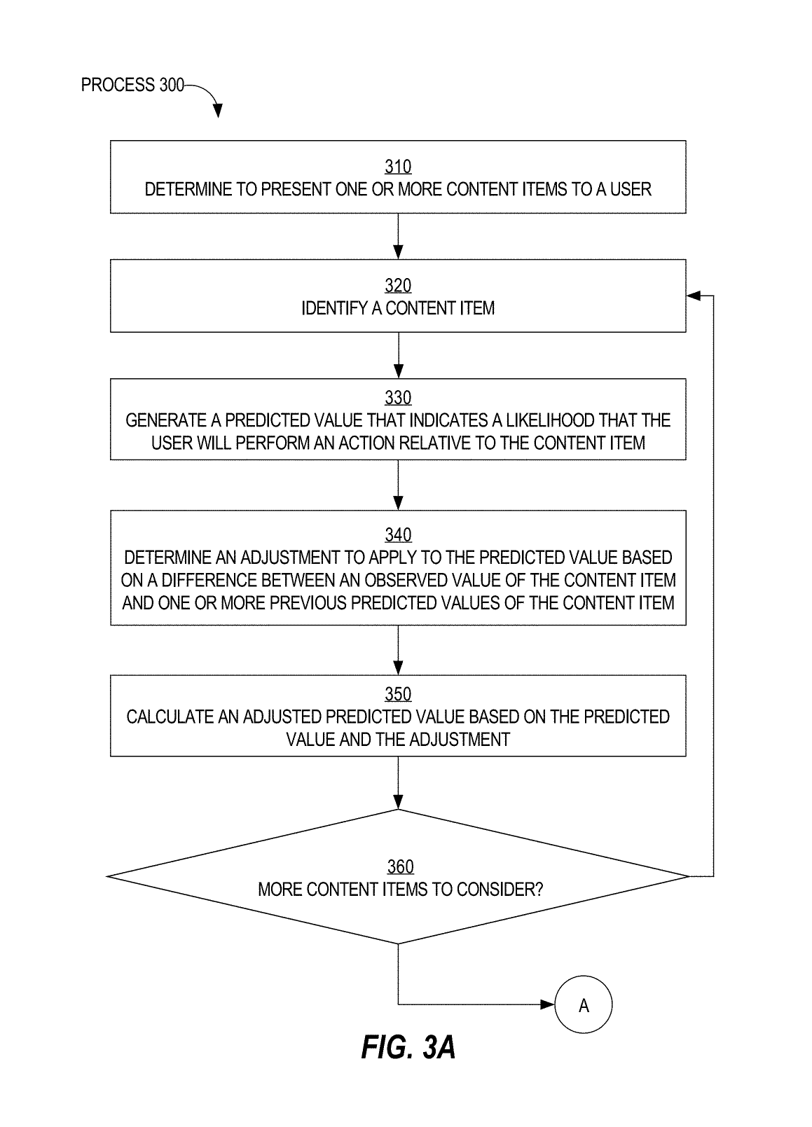

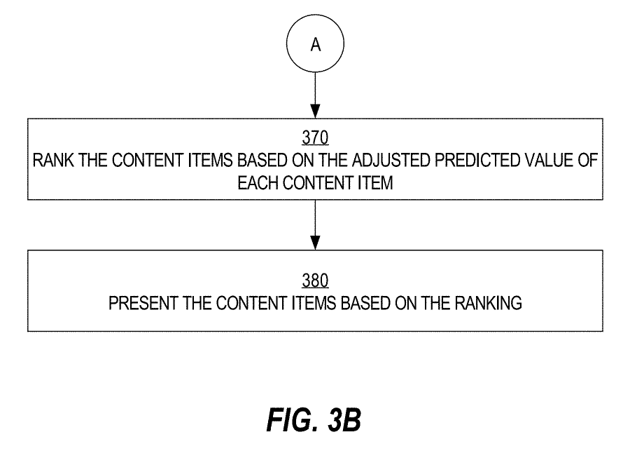

FIGS. 3A-3B are a flow diagram that depicts a process 300 for predicting a particular user behavior with respect to one or more candidate content items to display, in an embodiment. Process 300 may be implemented by user behavior predictor 134.

At block 310, a determination is made to present one or more content items to a user of client 110. This determination may be made in response to receiving a request for content from client 110. For example, the request may be to view a home page of a social network account.

At block 320, user behavior predictor 134 identifies a content item from content item database 132. Prior to commencement of process 300, the content item (and other content items) may be stored in (faster) volatile memory rather than waiting to receive the content item from non-volatile, persistent storage.

At block 330, user behavior predictor 134 generates a likelihood of particular user behavior with respect to the content item. The particular user behavior may be selecting the content item, in which case the likelihood is CTR. Block 330 may involve applying a set of rules based on known factors, such as the type of content item and information about the user and/or computing device of the user. Alternatively, block 330 may involve inputting, into a trained statistical model, multiple features related to the content item, context, and/or the user. The model generates a predicted value that indicates the likelihood. The value may be between 0 and 1.

At block 340, content item calibrator 136 determines an adjustment to apply to the predicted value based on a difference between (1) one or more observed values of the content item and (2) one or more previous predicted values of the content item. For example, if an observed CTR of the content item on a day 1 is 0.023 and a previous predicted CTR of the content item on day 1 is 0.018, then the difference is 0.005. As noted previously, content item calibrator 136 may take into account one or more other factors when determining (e.g., calculating) the difference. In some cases, an observed value and a previous predicted value may be the same, in which case, no adjustment is necessary. Additionally, if the difference is lower than a certain threshold (e.g., 0.001), then no adjustment may be applied.

At block 350, an adjusted predicted value is calculated based on the predicted value and the determined adjustment. In a scenario where the content item is an advertisement, then an expected value is generated for the content item based on the adjusted predicted value and a bid price associated with the content item.

At block 360, a determination is made regarding whether there are more content items to consider. Block 360 may involve determining how many content items may be displayed concurrently on a screen of client 110. The more content items that may be concurrently displayed, the greater the number of content items to consider. For example, if five content items may be displayed concurrently, then ten content items may be considered because the user may be able to scroll to a new position with a webpage or news feed. If this determination is positive, then process 300 proceeds to block 320. If this determination is negative, then process 300 proceeds to block 370.

At block 370, content item ranker 136 ranks the content items based on the adjusted predicted value associated with each content item. If the content items are advertisements, then expected values are calculated and used to rank the content items

At block 380, the content items are presented (e.g., displayed or played) based on the ranking determined in block 370. For example, if ten content items were ranked and only five content items can be displayed concurrently on a screen of client 110, then five content items that are the most highly ranked are displayed. Block 380 may involve sending all content items to client 110, where client 110 determines which content items to display first based on the rankings, which are determined by server system 130.

### Explore and Exploit

In an embodiment, the adjusted predicted value (calculated in block 350) is modified based on an explore value that may be generated dynamically (and randomly) for each content item or for certain content items, such as “new” content items (or content items for which there is very little user behavior history) or content items that are associated with relatively low predicted values, either at the time of generating the predicted values or over a period of time (e.g., two days). This modification would occur prior to content item ranking (i.e., in block 370).

The randomness may be bounded by a (e.g., normal) distribution around the adjusted predicted value. For example, the explore value is limited to the range defined by +/−(0.1*the adjusted predicted value). A purpose of the explore value is to allow content items that have low predicted values to have a chance to be presented more often than they otherwise would. As the same time, content items that have consistently high predicted values may have their predicted values increase at times, in which case (as a result of being presented more often) it may be learned that the observed rate increases significantly.

### Additional Calibration

In some cases where content items are advertisements, revenue for some content items may come from presenting (e.g., displaying) the content items, while revenue for other content items may come from users selecting the content items. The former content items are referred to as “impression items” and the latter content items are referred to as “CTR items.” In other words, a first advertiser will pay a content distributor X if an impression item is displayed to a user while a second advertiser (which may be the same as the first) will only pay the content distributor Y if a CTR item is selected by (e.g., clicked on) by a user. Y may be significantly more than X, but because there is no predicted value associated with an impression item, X is roughly equal to Y*predicted value. If X is very large, then very few CTR items will be presented, while if X is relatively small, then very few impression items will be presented.

If it is discovered that relatively few impression items are displayed relative to CTR items (or vice versa), then an additional adjustment is determined. For example, if CTR items are displayed much more often than impression items, then each adjusted predicted CTR (calculated for multiple CTR items) is multiplied by a factor (e.g., 0.95) in order to reduce the final rankings of all CTR items relative to impression items.

A reason such additional calibration is important is because predicted CTR is part of the pricing model. If user behavior predictor 134 systematically over estimates, then CTR items are given an extra discount; therefore, content providers of CTR items (e.g., advertisers) pay less then what they should pay and content providers of impression items (e.g., other advertisers) have to pay more. Such unfairness will affect market efficiency and revenue.

### Recording Newly-Generated Predicted Values

Content items may be presented constantly to end users. In order to determine accurate adjustments in the future, user interaction with those content items is constantly tracked. For example, on day 2, user behavior predictor 134 generates a predicted CTR for a content item. Then, content item calibrator 136 determines an adjustment for the content item based on a difference between an observed CTR (of the content item) on day 1 and a predicted CTR (of the content item) on day 1. The adjustment is then used to generate an adjusted predicted CTR, which is used to rank the content item relative to other content items. Then, if the content item is displayed, then user behavior with respect to the content item is tracked. As a result of the content item being displayed (e.g., multiple times to multiple users), an observed CTR is calculated for day 2 and a predicted CTR is calculated for day 2. The predicted CTR of the content item for day 2 would be based on the predicted CTR generated by user behavior predictor 134 rather than the adjusted predicted CTR.

If a predicted CTR is determined on a daily basis and stored on a daily basis for later adjustment calculation, then the first time a predicted CTR for a content item is determined, that predicted CTR is stored in association with the content item. Later determinations of the predicted CTR on the same day do not have to be stored or logged for later adjustment calculation.

### Testing the Calibration

In an embodiment, before applying content item calibrator 136 to content items that are to be served by server system 130 to end users, content item calibrator 136 is first applied to a “replay” of previously-presented content items. By running such an “experiment,” an administrator of server system 130 can make sure that deploying content item calibrator 136 so that it generates reasonable adjustments for “raw” predicted values (e.g., CTRs).

For example, a set of previous results is identified. Each previous result indicates a predicted value for each content item in a set of one or more content items that was displayed (concurrently in the scenario where there are multiple content items in the set) to an end user (e.g., of client 110). The predicted value (and not an adjusted content item) for each content item was used to score and, optionally, rank the content item. For each previous result in the set of previous results, the predicted value for each content item in the set of one or more content items is adjusted using content item calibrator 136.

If a set of one or more content items is a single content item, then it is determined whether the single content item would have still been presented based on the adjusted predicted value. If so, then a test record is stored that indicates whether the single content item was actually selected when it was presented to a “real” user. The test record is used along with other “test” records that are associated with the same single content item in order to generate a “test” observed value (or CTR).

If a set of one or more content items multiple content items, then an updated ranking of the multiple content items is determined based on the adjusted predicted value. If the ranking of the adjusted content items is the same, then a test record is stored for each of the multiple content items that indicates whether the content item was actually selected when it was presented to a “real” user. If the ranking of the adjusted content items is different, then the content items that are in a different order are excluded from the “replay” and test records are generated only for the remaining content items. The test records that are associated with the same content item are used to generate a test observed value (e.g., CTR).

The test observed values may be stored at the same time granularity (e.g., a day) as the actual observed values (i.e., associated with actual requests from end users).

Later, one or more test observed values of a content item are compared to one or more test predicted values (corresponding to the same time frame as the test observed values) of the content item to determine a difference. If the difference is less than a difference between actual observed values and actual predicted values, then this is evidence that content item calibrator 136 may be ready for production, i.e., being applied to content items that are to be served to end users submitting “live” requests to server system 130.

Tests for different content items may yield different results. For example, a test for one content item may indicate that the difference between test observed values and test predicted values has decreased while a test for another content item may indicate that the difference between test observed values and test predicted values has increased. Thus, the number of content items that are associated with a decreased difference (and, optionally, the amount of the decreased difference) may be a basis in determining whether to deploy content item calibrator 136.

In an embodiment, multiple experiments are applied to the same set of previous results except that a different version of content item calibrator 136 is used for each experiment. For example, in one experiment, the number of previous CTR days that are considered when determining a difference observed values and predicted values is five while, in another experiment, the number of previous CTR days that are considered when determining a difference is two. As another example, in multiple experiments, the same number of previous CTR days are considered when determining a difference, but at least some of the weights applied to each previous CTR day are different.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

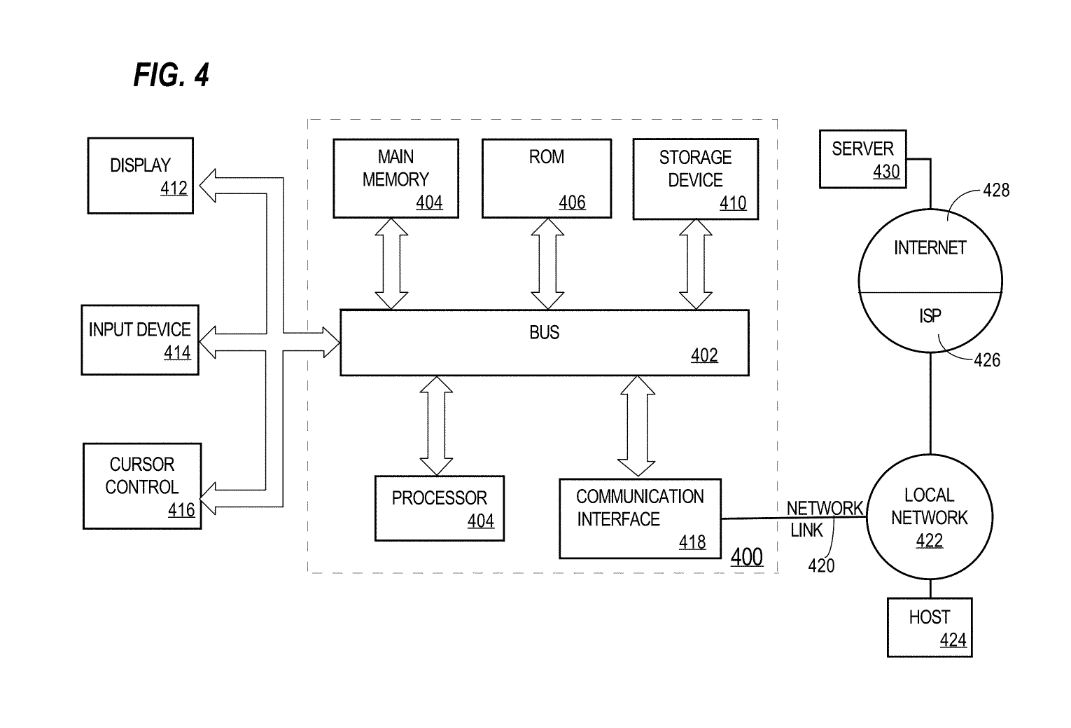

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
determining a difference between (1) an observed user selection rate of a first content item and (2) a previous predicted user selection rate of the first content item;
receiving, over a network, a request for one or more content items;
in response to receiving the request:
identifying the first content item;
generating, using a model, a current predicted user selection rate of the first content item;
based on the difference and without using the model, generating an adjusted predicted user selection rate of the first content item by increasing or decreasing the current predicted user selection rate of the first content item;
generating, based on the adjusted predicted user selection rate, a score of the first content item;
causing the first content item to be displayed based on the score of the first content item;
wherein the method is performed by one or more computing devices.

2. The method of claim 1, further comprising:
for each content item in a plurality of content items:
generating, using the model, a particular predicted user selection rate of said each content item;
determining, based on a particular difference between a particular observed user selection rate of said each content item and a particular previous user selection rate of said each content item;
modifying, based on the particular difference, the particular predicted user selection rate of said each content item to generate a particular adjusted predicted user selection rate of said each content item;
generating, based on the particular adjusted predicted user selection rate, a particular score of said each content item;
determining a ranking of the plurality of content items based on the particular score generated for each content item in the plurality of content items;
causing the plurality of content items to be displayed concurrently based on the ranking.

3. The method of claim 2, wherein:
each content item in the plurality of content items is associated with a bid value;
generating the particular score of said each content item comprises generating the particular score also based on the bid value associated with said each content item.

4. The method of claim 1, wherein the observed user selection rate is a first observed user selection rate, the difference is a first difference, and the current predicted user selection rate is a first predicted user selection rate, the method further comprising, after causing the first content item to be displayed:
storing the first predicted user selection rate of the first content item;
storing a second observed user selection rate of the first content item, wherein the second observed user selection rate of the first content item is different than the first observed user selection rate of the first content item;
generating, using the model, a second predicted user selection rate of the first content item;
determining a second difference between (3) the second observed user selection rate of the first content item and (4) the first predicted user selection rate of the first content item;
generating, based on the second difference, a second adjusted predicted user selection rate of the first content item by increasing or decreasing the second predicted user selection rate of the first content item;
generating, based on the second adjusted predicted user selection rate, a second score of the first content item;
causing the first content item to be displayed based on the second score of the first content item.

5. The method of claim 1, further comprising:
generating, using the model, a second predicted user selection rate of a second content item;
determining whether to use user selection rate information related to one or more content items other than the second content item in determining an adjustment to the second predicted user selection rate;
in response to determining to use user selection rate information related to one or more content items other than the second content item, determining a second difference between (1) a second observed user selection rate of the one or more content items and (2) a second previous predicted user selection rate of the one or more content items;
generating, based on the second difference, a second adjusted predicted user selection rate of the second content item by increasing or decreasing the second predicted user selection rate of the second content item;
generating, based on the second adjusted predicted user selection rate, a second score of the second content item;
causing the second content item to be displayed based on the second score of the second content item.

6. The method of claim 5, wherein determining whether to use the user selection rate information comprises determining that no user selection rate information exists for the second content item.

7. The method of claim 1, wherein the adjusted predicted user selection rate is a first adjusted user selection rate, further comprising:
prior to generating the score:
determining a variance value based on a distribution, and
generating, based on the variance value and the first adjusted predicted user selection rate, a second adjusted predicted user selection rate;
wherein generating the score comprises generating the score based on the second adjusted predicted user selection rate.

8. The method of claim 1, wherein the score is a first score, the method further comprising:
generating a second score for a second content item that is different than the first content item, wherein the second score is not generated based on a predicted user selection rate of the second content item;
wherein causing the first content item to be displayed comprises causing the first content item and the second content item to be displayed concurrently.

9. The method of claim 8, further comprising:
prior to generating the first score:
determining an additional calibration value, and
generating, based on the additional calibration value and the adjusted predicted user selection rate, a second adjusted predicted user selection rate;
wherein generating the first score comprises generating the first score based on the second adjusted predicted user selection rate;
wherein the second score is not generated based on the additional calibration value.

10. The method of claim 9, wherein:
the first content item is one of a plurality of content items;
the method further comprising, for each content item in the plurality of content items, generating a different score for said each content item based on the additional calibration value and a predicted user selection rate of said each content item;
causing the first content item to be displayed comprises causing the plurality of content items to be displayed concurrently based on the different score generated for each content item in the plurality of content items.

11. A system comprising:
one or more processors;
one or more computer-readable media storing instructions which, when executed by the one or more processors, cause:
determining a difference between (1) an observed user selection rate of a first content item and (2) a previous predicted user selection rate of the first content item;
receiving, over a network, a request for one or more content items;
in response to receiving the request:
identifying the first content item;
generating, using a model, a current predicted user selection rate of the first content item;
based on the difference and without using the model, generating an adjusted predicted user selection rate of the first content item by increasing or decreasing the current predicted user selection rate of the first content item;
generating, based on the adjusted predicted user selection rate, a score of the first content item;
causing the first content item to be displayed based on the score of the first content item.

12. The system of claim 11, wherein the instructions, when executed by the one or more processors, further cause:
for each content item in a plurality of content items:
generating, using the model, a particular predicted user selection rate of said each content item;
determining, based on a particular difference between a particular observed user selection rate of said each content item and a particular previous user selection rate of said each content item;
modifying, based on the particular difference, the particular predicted user selection rate of said each content item to generate a particular adjusted predicted user selection rate of said each content item;
generating, based on the particular adjusted predicted user selection rate, a particular score of said each content item;
determining a ranking of the plurality of content items based on the particular score generated for each content item in the plurality of content items;
causing the plurality of content items to be displayed concurrently based on the ranking.

13. The system of claim 12, wherein:
each content item in the plurality of content items is associated with a bid value;
generating the particular score of said each content item comprises generating the particular score also based on the bid value associated with said each content item.

14. The system of claim 11, wherein the observed user selection rate is a first observed user selection rate, the difference is a first difference, and the current predicted user selection rate is a first predicted user selection rate, wherein the instructions, when executed by the one or more processors, further cause, after causing the first content item to be displayed:
storing the first predicted user selection rate of the first content item;
storing a second observed user selection rate of the first content item, wherein the second observed user selection rate of the first content item is different than the first observed user selection rate of the first content item;
generating, using the model, a second predicted user selection rate of the first content item;
determining a second difference between (3) the second observed user selection rate of the first content item and (4) the first predicted user selection rate of the first content item;
generating, based on the second difference, a second adjusted predicted user selection rate of the first content item by increasing or decreasing the second predicted user selection rate of the first content item;
generating, based on the second adjusted predicted user selection rate, a second score of the first content item;
causing the first content item to be displayed based on the second score of the first content item.

15. The system of claim 11, wherein the instructions, when executed by the one or more processors, further cause:
generating, using the model, a second predicted user selection rate of a second content item;
determining whether to use user selection rate information related to one or more content items other than the second content item in determining an adjustment to the second predicted user selection rate;
in response to determining to use user selection rate information related to one or more content items other than the second content item, determining a second difference between (1) a second observed user selection rate of the one or more content items and (2) a second previous predicted user selection rate of the one or more content items;
generating, based on the second difference, a second adjusted predicted user selection rate of the second content item by increasing or decreasing the second predicted user selection rate of the second content item;
generating, based on the second adjusted predicted user selection rate, a second score of the second content item;
causing the second content item to be displayed based on the second score of the second content item.

16. The system of claim 15, wherein determining whether to use the user selection rate information comprises determining that no user selection rate information exists for the second content item.

17. The system of claim 11, wherein the adjusted predicted user selection rate is a first adjusted user selection rate, wherein the instructions, when executed by the one or more processors, further cause:
prior to generating the score:
determining a variance value based on a distribution, and
generating, based on the variance value and the first adjusted predicted user selection rate, a second adjusted predicted user selection rate;
wherein generating the score comprises generating the score based on the second adjusted predicted user selection rate.

18. The system of claim 11, wherein the score is a first score, wherein the instructions, when executed by the one or more processors, further cause:
generating a second score for a second content item that is different than the first content item, wherein the second score is not generated based on a predicted user selection rate of the second content item;
wherein causing the first content item to be displayed comprises causing the first content item and the second content item to be displayed concurrently.

19. The system of claim 18, wherein the instructions, when executed by the one or more processors, further cause:
prior to generating the first score:
determining an additional calibration value, and
generating, based on the additional calibration value and the adjusted predicted user selection rate, a second adjusted predicted user selection rate;
wherein generating the first score comprises generating the first score based on the second adjusted predicted user selection rate;
wherein the second score is not generated based on the additional calibration value.

20. The system of claim 19, wherein:
the first content item is one of a plurality of content items;
the instructions, when executed by the one or more processors, further cause, for each content item in the plurality of content items, generating a different score for said each content item based on the additional calibration value and a predicted user selection rate of said each content item;
causing the first content item to be displayed comprises causing the plurality of content items to be displayed concurrently based on the different score generated for each content item in the plurality of content items.
